(19) United States
(12) Patent Application Publication
(10) Pub. No.: US 2009/0124475 A1
(43) Pub. Date: May 14, 2009

(54) FIXING MEMBER

(76) Inventors: Jerry A. Pickering, Hilton, NY (US); James V. Orchard, Holley, NY (US); Thomas M. Plutchak, Hilton, NY (US)

Correspondence Address: Andrew J. Anderson, Patent Legal Staff,;Eastman Kodak Company,, 343 State Street, Rochester, NY, 14650-2201, US

(21) Appl. No.: 11/938,893

(22) Filed: Nov. 13, 2007

(51) Int. Cl. F16C 13/00; B21D 53/00

(52) U.S. Cl. 492/47; 29/895.2

(57) ABSTRACT

The present invention is a roller for use in a fuser assembly of a reproduction apparatus. The roller includes a generally elongated substantially cylindrical tube having two ends. End gudgeons having a cylindrical wall extending from a surface of the gudgeon matching the cylindrical tube are welded to the ends of the cylindrical tube. The present invention is also a method to manufacture a fixing roller or core.

### FIELD OF THE INVENTION

This invention relates in general to rollers or members, for example for use in fuser assemblies of reproduction apparatus, and more particularly to construction of fuser, pressure, or heater rollers capable of operating at elevated temperatures.

### BACKGROUND OF THE INVENTION

In reproduction apparatus, such as copier/duplicators and printers for example, fuser rollers or heated rollers are commonly used which include two end caps, which can be made from stainless steel, that are joined to a thermally conductive tube such as aluminum or coppers or alloys of these two materials. There are many known methods for joining the end caps to the tube, such as mechanically bolting, press fit, retaining rings, welding etc. If the end caps and tube are made from the same material, forming techniques such as spinning and swaging can be employed where joining techniques are not required.

Due to its low cost, one of the most commonly methods for joining end caps to tubing is by friction welding. Friction welding can be either inertia or direct drive friction welding. If the end cap and the tube include materials that are weldable, then a butt type weld design can be used (see EP 0 395 385 published Nov. 31, 1990). If the end cap and the tube include materials that are not readily weldable, than an open dovetail weld design can be used (see U.S. Pat. No. 5,094,613).

It has been found, however, that under severe stress conditions, an open dovetail design results in joint failure if the stresses exceed the yield point of the materials being used. One major component of these stresses is the loading imparted along the length of the roller. Another major component of these stresses is as a result of the differential coefficient of thermal expansion of the two materials from room temperature to fusing core operating temperature. The higher the operating temperature of the fuser roll, the higher the stresses created at the joint due to the differential rates of material expansion.

U.S. Pat. No. 6,589,048 describes a roller for use in a fuser assembly wherein end gudgeons are provided for sealing the ends of the cylindrical tube. The roller includes a generally elongated substantially cylindrical tube. End gudgeons are provided for sealing the ends of the cylindrical tube. Each of the end gudgeons is respectively associated with an end of the cylindrical tube such that after a bonded joint is formed between the cylindrical tube and the end gudgeon, the end gudgeon provides a compression joint to prevent the cylindrical tube from separating from the end gudgeon, due to material creep, at elevated operating temperatures. However, the process of making this roller is more costly than desirable and the gudgeons are a different material from the elongated tube.

It would be desirable to provide a fixing roller for use in electrophotographic machines that is durable, manufacturable and provides long life.

### ADVANTAGES

The present invention provides a durable fixing roller core resistant to cyclic fatigue at elevated temperatures. It further provides a fixing roller core wherein the intersection of the gudgeon and the tube is free of cracks and discontinuities. Another advantage of the present invention is that conduction losses to the gudgeon of the heat generated during welding of the gudgeon and tube are minimized providing a superior weld. Yet another advantage of the present invention is that the internal discontinuity that inevitably results from a welding process is positioned at a location of minimum stress. Still another advantage is the lower cost of the member.

### SUMMARY OF THE INVENTION

The present invention is a roller for use in a fuser assembly of a reproduction apparatus. The roller includes a generally elongated substantially cylindrical tube having two ends. End gudgeons having a cylindrical wall extending from a surface of the gudgeon matching the cylindrical tube are welded to the ends of the cylindrical tube. The present invention is also a method to manufacture a fixing roller or core.

### BRIEF DESCRIPTION OF THE DRAWINGS

FIG. 1 is a side elevation view, in cross-section, of a roller having and end cap or gudgeon secured to a tube by an open dovetail weld joint according to the prior art.

FIG. 2 is a side elevation view, in cross-section of end cap or gudgeon of the present invention.

FIG. 3 is a side elevation view in cross-section of an end cap positioned in relation to the tube.

FIG. 4 is a side elevation view, in cross-section, of a roller having and end cap or gudgeon secured to a tube by a weld joint according to the present invention.

FIG. 5 is a side elevation view, in cross-section, of a roller having and end cap or gudgeon secured to a tube by tapered weld joint according to the prior art.

FIG. 6 is an angled view of a roller having and two end caps or gudgeons secured by flat weld joint according to the prior art.

For a better understanding of the present invention together with other advantages and capabilities thereof, reference is made to the following description and appended claims in connection with the preceding drawings.

### DETAILED DESCRIPTION OF THE INVENTION

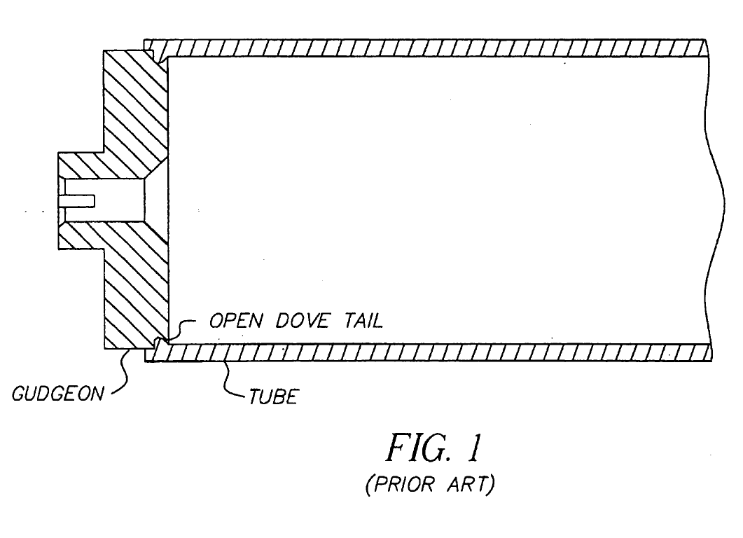

A roller or member is typically constructed by welding the end gudgeons to the tube, with one common welding technique being a friction weld joint producing open dovetail joint. This is shown in FIG. 1. Prior art friction welds are subject to failure.

According to the present invention, the friction weld joint is made using a gudgeon that has a circular portion extending from a surface of the gudgeon or end cap wherein the circular portion matches the end of the tube. The gudgeon is then spun in relation to the tube and the gudgeon and tube are brought into contact at the tube end and the circular portion extending from the gudgeon surface. The friction caused by the contact of the surfaces produces heat that melts the metal thereby welding the gudgeon and the tube. When the weld is complete, an extension of material extends form the outer surface of the tube that is then smoothed through some type of grinding operation.

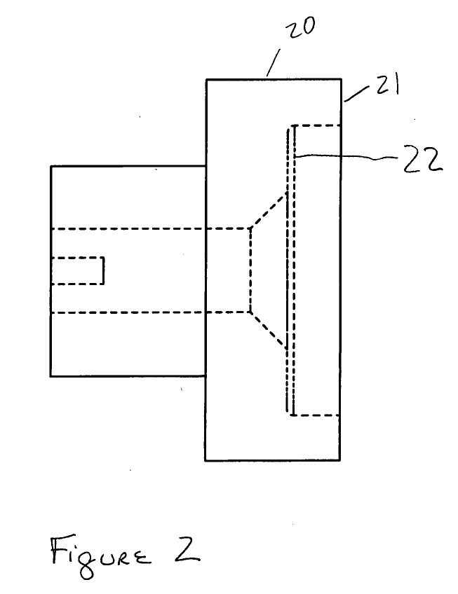

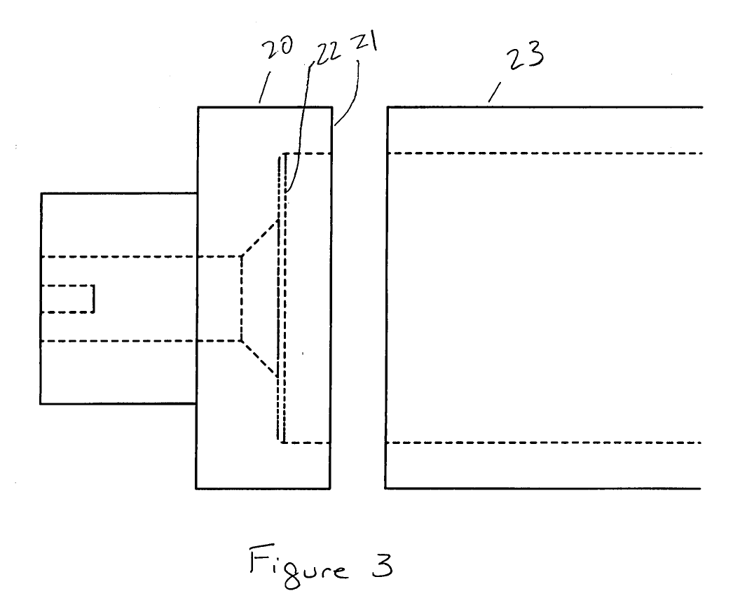

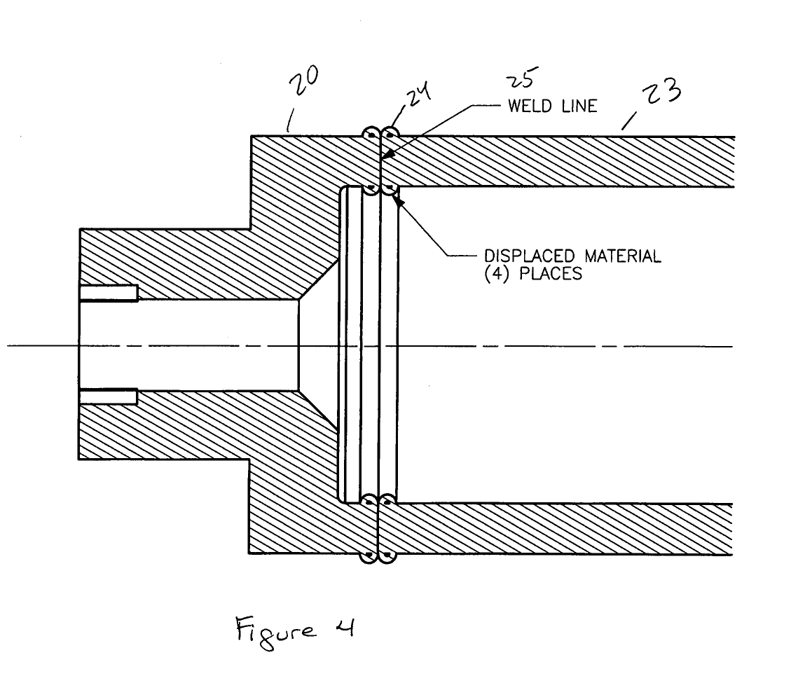

In FIGS. 2-4, a gudgeon or end cap 20 of the present invention is shown. The end cap has a circular lip 21 extending from a surface 22. The circular lip 22 matches the end of tube 23. As can be seen in FIG. 4, the spin welding displaced material 24 is produced at the weld line 25. The displaced material makes the wall thickness wider in the area of the weld. The displaced material also counteracts any stress increase that is present from the intersection of the weld curls. After welding, the outer surface of the tube is smoothed through grinding or polishing. It is preferred that the faces of the circular lip and the end of the tubes are substantially parallel to each other. It is preferred that the surfaces are flat but other configurations are possible.

Welding by definition requires that compatible materials be combined. The alloys do not need to be identical but they do need to be in the same base element. Many combinations of materials can be chosen as long as they are in the base element and as long as they are compatible. i.e. aluminum alloy to a different compatible aluminum alloy. One needs to conduct the tests to see which alloys give a sufficient weld. Materials that can be used in the present invention include aluminum alloys. Aluminum alloys are preferred for fusing rollers due to the aluminum alloys heat conducting properties. With an internally heated roller, the core must conduct heat through the core and then through the outer coating, typically an elastomer or thermoplastic. Materials with lower thermal conductivity such as steel require higher temperatures to conduct the same amount of heat. The higher temperature can reach the point of damaging the outer coating or other components such as the bearings or bearing insulators. Therefore, with an internally heated roller, an aluminum alloy is usually chosen.

Steel and/or stainless steel can be combined for use in rollers where the temperatures are not as high. Other applications where steel could be used are rollers with no internal heat source. There are examples of no internal heat, an unheated roller or an externally heat roller system. These systems are used in the electrophotographic industry. Copper alloys have excellent thermal conductivity but the material costs tend to be prohibitive.

### Compatibility of Alloys for Spin Welding

The fuser roll tube and end gudgeon are made of similar materials otherwise a weld could not occur. The preferred material is aluminum or aluminum alloys. Aluminum alloys often have percentages of copper, zinc, manganese, silicon, or magnesium. The alloys do not have to be identical. There are many different aluminum alloys that can be spin welded to a different alloy. There are also alloys that are not compatible. An important example is where an alloy used for castings, typically used for the gudgeons, can be welded to an alloy used for extruding tube stock. This generally helps to lower cost. In the examples described below the material used was an aluminum alloy (Aluminum 6061) available from Alcoa and other sources. The general operating temperature of the fuser roll core in this example is in the range of between approximately 200° C. and 400° C.

The present invention provides a durable fixing roller core resistant to cyclic fatigue at elevated temperatures wherein the core comprises an aluminum or aluminum alloy tube and gudgeons welded together wherein the weld location is located within the tube portion of the resulting fixing roller core. The internal radius at the intersection of the gudgeon and fixing roller core is free of cracks or discontinuities. In the prior art this is not possible as tube is welded against the surface of the gudgeon. In a preferred embodiment, the internal location of the weld line at the fixing core ID is at least 2 mm from the median location of the gudgeon surface. At the center of the fixing roller core the stress increases due to bending of the core. The location of the weld is preferably in the region of lower stress between the corner of the core ID and the center of the core. This location of the weld is at least 2 mm from the inner face of the gudgeon. Preferably, the weld is about 10 to 13 mm from the gudgeon inner face, or a length of no more than about ⅛ the full length of the fixing roller. The weld is preferably an inertial weld, such as spin-welding. The spin-welding operation compresses the total length of the joined parts, where the difference between the sum of the starting lengths of the parts and the final length of the joined parts is the upset. The upset is preferably at least about 3 mm. More preferably, the upset is from 4 to 10 mm. In the Examples of the invention below the upset length was about 7.6 mm.

### EXAMPLES

The Examples below are summarized in Table 1.

### Angled Weld

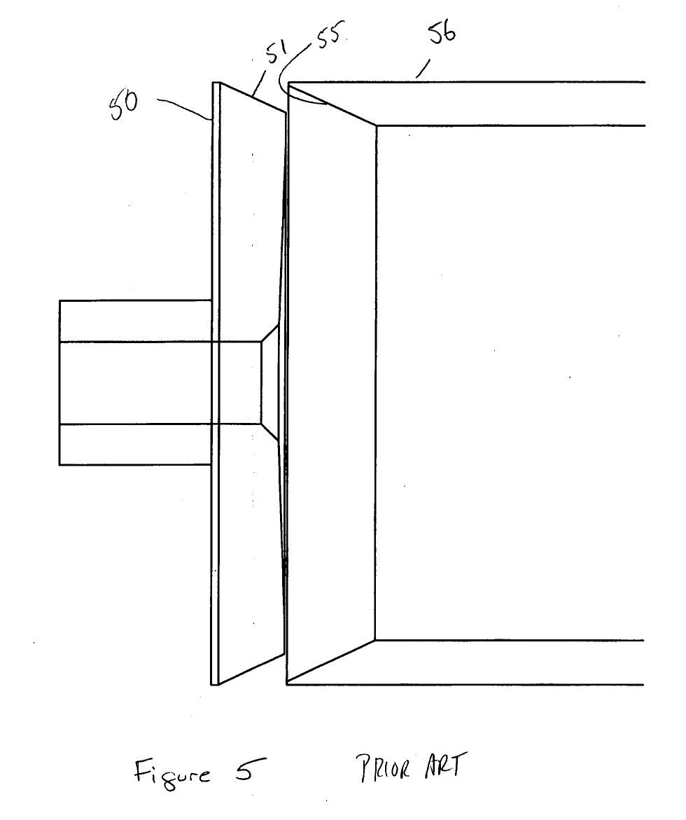

Aluminum alloy 6061 pressure roller gudgeons having a maximum outer diameter of 3.5 inches were prepared with area of contact to an aluminum alloy tube machined at an angle of 25 degrees, such that the inner flat face of the gudgeon was 2.81 inches in diameter. This is shown in FIG. 5 wherein and end gudgeon 50 has a tapered outer surface 51 that matches the tapered end 55 of the tube 56

Cylindrical extruded aluminum alloy tubes having an outer diameter of 3.5 inches and an inner diameter of 2.81 inches were prepared with the end of the tubes forming a similar cone angle of 25 degrees from the tube axis. The tubes and gudgeons were spin welded together. The weld interface passed a static bending and tensile test.

Machined cores were placed in a stand-alone fuser stress test fixture instrumented to run standard speed at a temperature of 270° C. under four times the expected operational load. The cores were monitored for breakage of the gudgeon-core interface and the time to failure noted. The results are shown in Table 1.

### Tube to Plate

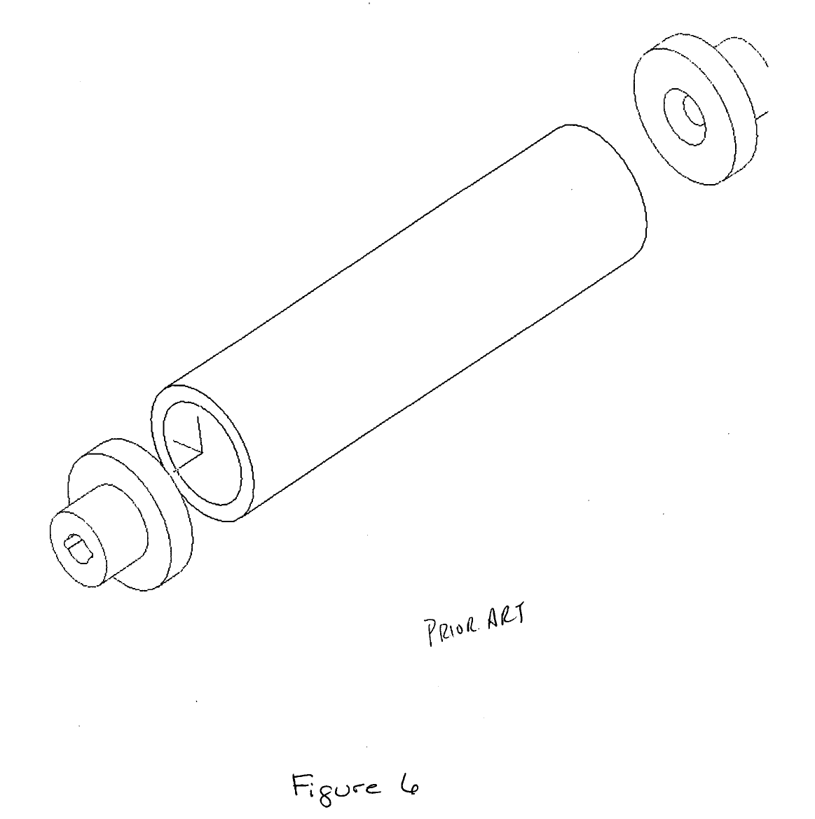

Aluminum alloy 6061 pressure roller gudgeons having an outer diameter of 3.625 inches were prepared with flat inner faces. Cylindrical extruded aluminum alloy tubes having outer diameters of 3.625 an inner diameter of 2.750 inches were prepared with the end of the tubes having a flat squared off faces 90 degrees from the tubes axis. The tubes and gudgeons were spin welded together. The tube to plate configuration is shown in FIG. 6. The weld interfaces passed a static bending and tensile test. Machined cores were monitored for breakage of the gudgeon-core interface and the time to failure noted. The results are shown in Table 1.

### Tube to Semi-tube

Cylindrical extruded aluminum alloy 6061 tubes having an outer diameter of 3.625 and an inner diameter of 2.750 inches were prepared with the end of the tubes having a flat squared off face 90 degrees from the tube axis. Aluminum alloy gudgeons having an outer diameter of 3.625 inches were prepared as shown in FIG. 4 with a semi-tube portion or lip extending 0.5 inches from the inner gudgeon surface. The end of the resulting cylindrical semi-tube was prepared with the end having a flat squared off face 90 degrees from the semi-tube axis to match the face of the main tube. The tubes and gudgeons were spin welded together. The weld interfaces passed a static bending and tensile test. Machined cores were evaluated as described in Example 1 and the results are shown in Table 1

TABLE 1

| | | Hours:min |
|---|---|---|
| Weld Type | Upset (inches) | To failure |
| Angled | | 1:5 |
| Angled | | 0:15 |
| Angled | | 2:40 |
| Tube to Plate | 0.3 | 58:15 |
| Tube to Plate | 0.3 | 17:40 |
| Tube to Plate | 0.3 | 90:45 |
| Tube to Plate | 0.3 | 46:05 |
| Tube to Semi-tube | 0.26 | >200:30* |
| Tube to Semi-tube | 0.26 | >196* |
| Tube to Semi-tube | 0.26 | >122* |
| Tube to Semi-tube | 0.26 | >329* |

*No failure occurred

The invention has been described in detail with particular reference to certain preferred embodiments thereof, but it will be understood that variations and modifications can be effected within the spirit and scope of the invention.

It is claimed:

1. A roller for use in a fuser assembly of a reproduction apparatus, said roller comprising: a generally elongated substantially cylindrical tube having two ends; two end gudgeons each having a cylindrical wall extending from a surface of the gudgeon wherein the cylindrical wall match the cylindrical tube at each end and the end walls are welded to each end of the cylindrical tube.

2. The roller of claim 1 wherein an internal radius at the intersection of the cylindrical wall and the surface of the gudgeon is free of cracks or discontinuities.

3. The roller of claim 2 wherein the internal radius at the intersection of the cylindrical end wall and the surface of the gudgeon is from 4 to 10 mm.

4. The roller of claim 1 wherein a weld location is located at least 2 mm from the surface of the gudgeon.

5. The roller of claim 1 wherein a weld location is located between 10 mm and 14 mm from the surface of the gudgeon.

6. The roller of claim 1 wherein a weld thickness is equal to or greater than a thickness of the cylindrical tube.

7. The roller of claim 1 wherein the tube and end gudgeons comprise aluminum or aluminum alloys.

8. The roller of claim 1 wherein the tube and end gudgeons comprise copper or copper.

9. The roller of claim 1 wherein the tube and end gudgeons comprise steel or stainless steel.

10. A method of producing a roller for use in a fuser assembly of a reproduction apparatus comprising:
providing a generally elongated substantially cylindrical tube having an outer surface and two ends;
providing an end gudgeon, said end gudgeon having a cylindrical wall extending from a surface of the gudgeon wherein the cylindrical wall matches one end of cylindrical tube; and
rotating and positioning the end gudgeon having the cylindrical wall in relation to said cylindrical tube wherein the cylindrical wall and an end of the tube contact each other creating frictional heat to form a weld.

11. The method of claim 10 further comprising:
smoothing the outer surface of the cylindrical tube.

12. The method of claim 10 wherein the tube and end gudgeon comprise aluminum or aluminum alloys.

13. The method of claim 10 wherein the tube and end gudgeon comprise copper or copper alloys.

14. The method of claim 10 wherein the tube and end gudgeon comprise steel or stainless steel.
